(19) United States
(12) Patent Application Publication
(10) Pub. No.: US 2018/0105694 A1
(43) Pub. Date: Apr. 19, 2018

(54) A SULPHUR ADDITIVE TO SUPPRESS HYDROGEN SULPHIDE EMISSIONS FROM SULPHUR EXTENDED ASPHALT

(71) Applicant: Reliance Industries Limited, Mumbai (IN)

(72) Inventors: Raksh Vir Jasra, Vadodara (IN); Yogesh Suresh Niwate, Bhayander (East) (IN); Kalpana Gopalakrishnan, Vadodara (IN); Satish Kumar, Gohana (IN); Prakash Kumar, Vadodara (IN); Lintoan John, Kottayam (IN); Mayur Navinchandra Talati, Rajkot (IN); Nagarathinam Shenbaga Murthy, Tuticorin (IN); Ravishankar Vishvasrao Desai, Kolhapur (IN)

(73) Assignee: Reliance Industries Limited, Mumbai (IN)

(21) Appl. No.: 15/560,672

(22) PCT Filed: Mar. 22, 2016
(86) PCT No.: PCT/IB2016/051597

§ 371 Date: Sep. 22, 2017

(30) Foreign Application Priority Data
Mar. 25, 2015 (IN) 1000/MUM/2015

(51) Int. Cl. C08L 95/00; E01C 7/26; C01B 17/16

(52) U.S. Cl. CPC C08L 95/00; E01C 7/267; B01J 29/06; C08L 2555/54; C01B 17/16

(57) ABSTRACT

The present disclosure relates to a sulphur additive to suppress hydrogen sulphide emissions from Sulphur Extended Asphalt. The sulphur additive of the present disclosure comprises 5 sulphur in an amount ranging from 80 to 98 wt % and at least one aluminosilicate in an amount ranging from 2 to 20 wt %. The sulphur additive of the present disclosure suppresses the H2S emission up to acceptable safe limit during the preparation and application of the sulphur extended asphalt at elevated temperature.

### FIELD

The present disclosure relates to a sulphur additive for the preparation of Sulphur Extended Asphalt and a process for preparation thereof.

### Definitions

As used in the present disclosure, the following terms are generally intended to have the meaning as set forth below, except to the extent that the context in which they are used indicate otherwise.

Pore size: Pore size is defined as the longest dimension per pore.

OSHA (Occupational Safety and Health Administration) standards: OSHA determines the permissible level of H₂S in the surrounding which is non-hazardous to human being. As per OSHA standards, H₂S emission up to 20 ppm can be considered non-hazardous.

Multi-gas detector apparatus is used for the detection of H₂S having detection sensitivity ranging between 1 ppm to 100 ppm (Resolution: 0.1 ppm).

Spent catalyst: A catalyst that has been used and as a result of contamination, can no longer serve the purpose, for which, it was produced.

Ordered Porous Structure: A porous material exhibiting well defined pores, arranged in a defined pattern, of pores of defined sizes.

### BACKGROUND

Use of viscosity grade bitumen for surface-dressing, spraying, construction and paving of roads is well known. Sulphur is mixed with bitumen to increase the mechanical strength, corrosion resistance, water resistance, Marshall Stability, fatigue, resilient modulus (RM) and the like. The mixture of bitumen with sulphur is called as Sulphur Extended Asphalt (SEA). During the process of preparing sulphur extended asphalt or placing SEA on the road surface, H₂S is released, which is harmful for human and animal life. OSHA has established a permissible exposure limit (PEL) for emission of H₂S (8 hour time-weighted average (TWA) of 10 ppm and acceptable ceiling concentration of 20 ppm).

The preparation of SEA and its application in laying on roads is usually carried out at elevated temperatures, wherein the H₂S is generated in the amount that is harmful to humans. Bitumen is melted at higher temperature for preparing a homogeneous mixture of SEA. Therefore, the temperature plays an important factor in the preparation and application of sulphur extended asphalt.

H₂S is generated by the reaction of bitumen and sulphur at high temperature (more than 120° C.). Sulphur has condensing effect upon asphalt under heating conditions, resulting in the formation of gaseous hydrogen sulphide as per the reaction given below:

CₓH_{y}+S→CₓH_{y-2}+H₂S(g)↑

The dissolved and entrained H₂S within the sulphur itself and/or within bitumen is released on melting.

Technologies used for the suppression of H₂S emission during the preparation of sulphur extended asphalt involves use of compositions selected from the group of tetraalkylthiuram disulphide, dithiocarbamates, amine compounds, iodine, copper salts, copper oxides, cobalt salts, iron salts and iron oxides. Other available technologies for the suppression of H₂S emission include the use of biological sulphur produced by biological conversion of sulphur comprising compounds such as sulphides and/or H₂S into elemental sulphur, addition of fillers (including mineral fillers) along with H₂S suppressants to the bitumen and the addition of sulphur granules.

However, the known technologies have shown limited success in H₂S suppression with increase in temperature during the preparation and application of sulphur extended asphalt.

There is, therefore, felt a need to develop an effective H₂S suppressant composition to overcome the drawbacks associated with the prior art.

### Objects

Some of the objects of the present disclosure, which at least one embodiment herein satisfies, are as follows:

An object of the present disclosure is to reduce the emission of hydrogen sulphide (H₂S) during the preparation of Sulphur Extended Asphalt.

Another object of the present disclosure is to reduce the emission of hydrogen sulphide (H₂S) during the application of Sulphur Extended Asphalt in road pavement.

Still another object of the present disclosure is to reduce the emission of hydrogen sulphide (H₂S) during the preparation of Sulphur Extended Asphalt to a temperature greater than 80° C.

Yet another object of the present disclosure is to ameliorate one or more problems associated with the conventional methods or at least provide a useful alternative.

Other objects and advantages of the present disclosure will be more apparent from the following description, which is not intended to limit the scope of the present disclosure.

### SUMMARY

In accordance with one aspect of the present disclosure, there is provided a sulphur additive for preparing sulphur extended asphalt, the sulphur additive comprising: a) sulphur in an amount ranging from 80 to 98 wt % of the sulphur additive; and b) at least one aluminosilicate in an amount ranging from 2 to 20 wt % of the sulphur additive.

The sulphur additive of the present disclosure suppresses H₂S emission up to an acceptable safe limit.

The present disclosure provides the processes for the preparation of sulphur additive and the preparation of sulphur extended asphalt.

### DETAILED DESCRIPTION

The present disclosure relates to a sulphur additive for reducing the emission of H₂S during the preparation and the application of sulphur extended asphalt (SEA). The sulphur additive of the present disclosure suppresses H₂S emission up to an acceptable safe limit during the preparation and the application of the SEA at elevated temperatures.

In accordance with one aspect of the present disclosure, there is provided a sulphur additive for the preparation of sulphur extended asphalt, wherein the sulphur additive comprises:
sulphur in an amount ranging from 80 to 98 wt % of the sulphur additive; and
at least one aluminosilicate in an amount ranging from 2 to 20 wt % of the sulphur additive.

In accordance with the present disclosure, the at least one aluminosilicate has an ordered porous structure with pore size in the range of 4 to 8 Å.

In accordance with one embodiment of the present disclosure, the aluminosilicate comprises at least one metal ion in its framework selected from the group consisting of alkali metals, alkaline earth metals, rare earth metals and transition metals.

The metal ion is inherently present or introduced in the framework of the aluminosilicate using known modification methods, before adding to sulphur for the preparation of the sulphur additive.

In accordance with another aspect of the present disclosure, there is provided a process for the preparation of a sulphur additive, wherein the process comprises the following steps:
sulphur is introduced in the reactor and heated to obtain a molten sulphur;
at least one aluminosilicate is added to the molten sulfur to obtain a mixture;
the mixture is heated at the temperature up to 170° C. and stirred to obtain a slurry; and
the slurry is cooled to obtain the sulphur additive;

In accordance with one embodiment of the present disclosure, sulphur, introduced into the reactor, is raw sulphur.

In accordance with one embodiment of the present disclosure, sulphur is in molten form.

In accordance with another embodiment of the present disclosure, the sulphur is melted before adding the at least one aluminosilicate to it.

The sulphur additive is molded into at least one solid shaped article selected from the group consisting of pastilles, flakes, extrudates and granules. The molding unit is selected from the group consisting of, but is not limited to, a pastillation unit, an extruder unit, a nodulizer unit, a granulator and the like to obtain at least one solid shaped article of the sulphur additive.

The step heating of sulphur to obtain the molten sulphur is carried out at a temperature in the range of 110 to 150° C. In accordance with one embodiment of the present disclosure, sulphur is heated to 150° C. to obtain molten sulphur.

The ratio of the amount of the aluminosilicate and the amount of sulphur is in the range of 1:4 to 1:15. In accordance with one embodiment of the present disclosure, the ratio of the amount of the aluminosilicate and the amount of sulphur is 1:12.

In accordance with the present disclosure, the at least one aluminosilicate is modified using at least one of the following processes:
In one method aluminosilicate is treated with a metal salt solution containing a commercially available adsorbents at ambient temperature for a time period in the range of 1 to 8 hours to obtain a mixture; the mixture is filtered to obtain a first residue; the first residue is washed and dried to obtain the modified aluminosilicate; and
another method of modifying at least one aluminosilicate is by treating aluminosilicate contained in a spent catalyst, wherein the process comprises the following steps: contacting aluminosilicate with a caustic aqueous solution to a temperature in the range of 30 to 60° C. for a time period in the range of 10 to 40 hours or sonication is carried out for a time period in the range of 10 to 120 minutes or heating with a caustic powder to a temperature in the range of 400 to 800° C. for a time period in the range of 1 to 4 hours to obtain a mixture; the mixture is hydrothermally heated to a temperature in the range of 70 to 100° C. under autogenic pressure for a time period in the range of 15 to 40 hours to obtain the modified aluminosilicate.

In accordance with one embodiment of the present disclosure, the aluminosilicate is at least one selected from the group consisting of virgin aluminosilicate and an aluminosilicate previously used as catalyst. The spent catalyst can be modified using one of the modification processes for aluminosilicate.

In accordance with yet another aspect of the present disclosure there is provided a process for the preparation of Sulphur Extended Asphalt, wherein bitumen is introduced in a reactor and heated to obtain a heated bitumen. Thereafter, the heated bitumen and the sulphur additive are mixed to obtain the Sulphur Extended Asphalt.

Bitumen is heated at a temperature in the range of 70 to 180° C.

In accordance with one embodiment of the present disclosure, the bitumen is heated at 165° C.

The weight ratio of the sulphur additive and the bitumen is in the range of 1:1 to 1:10.

The Sulphur Extended Asphalt prepared using the sulphur additive of the present disclosure shows the decreased H₂S emission at a temperature in the range of 110 to 180° C.

The process for the preparation of Sulphur Extended Asphalt comprises mixing the sulphur additive and bitumen at a temperature in the range of 110 to 190° C., preferably between 135 to 180° C., under stirring with a speed of less than 100 rpm, preferably less than 70 rpm.

In one of the embodiment, the solid bitumen and the sulphur additive are mixed together before heating.

The present disclosure is further described in light of the following experiments which are set forth for illustration purpose only and not to be construed for limiting the scope of the disclosure. The following experiments can be scaled up to industrial/commercial scale and the results obtained can be extrapolated to industrial scale.

### Experiment 1: Process for the Preparation of a Sulphur Additive

A reactor was charged with 30 g of sulphur. The sulphur was heated to 150° C. to obtain molten sulphur. 2.5 g of zeolite was added to the molten sulphur to obtain a slurry. The slurry was continuously stirred to make a homogeneous mixture. The homogeneous mixture was cooled to obtain the sulphur additive.

Experiment 2A: Preparation of Sulphur Extended Asphalt Using a Sulphur Additive (Containing Aluminosilicate with Alkali/Alkaline Earth Metal Ions)

A flask was charged with 70 g of bitumen. The bitumen in the flask was heated to 165° C. to obtain heated bitumen. 30 g of sulphur additive of experiment 1 was added to the heated bitumen to obtain a homogeneous mixture. The homogeneous mixture was stirred at a speed of 100 rpm. The emission of hydrogen sulphide (H₂S) from the flask was monitored in the temperature range of 120° C. to 180° C. using a multi-gas detector.

TABLE 2A
H₂S emission at increasing temperature

| Sulphur | | | | H₂S emission |
|---|---|---|---|---|
| additive | Bitumen | Stirring rate | Temperature | on detector |
| (wt %) | (wt %) | (rpm) | (° C.) | (ppm) |
| 30 | 70 | 70 | 120 | 0 (undetectable) |
| 30 | 70 | 70 | 140 | 0 (undetectable) |
| 30 | 70 | 70 | 160 | 0 (undetectable) |
| 30 | 70 | 70 | 170 | 2 |
| 30 | 70 | 70 | 180 | 4 |

It was observed that the emission of hydrogen sulphide (H₂S) and sulphur dioxide (SO₂) during the preparation of sulphur extended asphalt at 160° C. was found to be 0 ppm. As temperature of the sulphur extended asphalt was further raised to 180° C., it was observed that the emission of hydrogen sulphide (H₂S) was 4 ppm, which is found to be well within the safer limit

### Experiment 2B: H₂S Emission from Sulphur Extended Asphalt (SEA) with Increasing Temperature

The sulphur extended asphalt samples prepared in Experiments 2A were cooled to room temperature. The cooled samples were further cut into pieces. The pieces were heated to 80° C. and the emission of hydrogen sulphide (H₂S) was monitored at different levels using multi-gas detector. It was observed that there was no emission of hydrogen sulphide (H₂S) and sulphur dioxide (SO₂) upto 80° C.

TABLE 2B
H₂S emission with increasing temperature

| SEA (wt %) | Temperature (° C.) | H₂S emission (ppm) |
|---|---|---|
| 100 | 40 | 0 (undetectable) |
| 100 | 60 | 0 (undetectable) |
| 100 | 80 | 0 (undetectable) |

### Experiment 3A: Preparation of Sulphur Extended Asphalt Using a Sulphur Additive (Containing Aluminosilicate with Rare Earth/Transition Metal Ions)

The experimental procedure was followed as reacted in Experiment 2A. The results are tabulated in Table 3A.

TABLE 3A

| sulphur additive | Bitumen | Stirring rate | Temperature | H₂S emission on |
|---|---|---|---|---|
| (wt %) | (wt %) | (rpm) | (° C.) | detector (ppm) |
| 30 | 70 | 70 | 120 | 0 (undetectable) |
| 30 | 70 | 70 | 140 | 0 (undetectable) |
| 30 | 70 | 70 | 160 | 0 (undetectable) |
| 30 | 70 | 70 | 170 | 0 (undetectable) |
| 30 | 70 | 70 | 180 | 2 |

No H₂S emission was noted up to 170° C.

### Experiment 3B: H₂S Emission from Sulphur Extended Asphalt with Increasing Temperature

Sulphur Extended Asphalt samples prepared in Experiments 3A were cooled to room temperature. The solid mass obtained was cut into pieces and heated to 80° C. to check H₂S emission. H₂S emission was checked at different levels using the multi-gas detector. At 80° C., no H₂S emission was observed at the zero inch level of the beaker brim.

TABLE 3B
H₂S emission from Sulphur Extended Asphalt (SEA) with
increasing temperature

| | | H₂S emission on detector |
|---|---|---|
| SEA (wt %) | Temperature (° C.) | (ppm) |
| 100 | 40 | 0 (undetectable) |
| 100 | 60 | 0 (undetectable) |
| 100 | 80 | 0 (undetectable) |

(The H₂S emission was monitored up to 80° C. on the basis of the fact that the maximum temperature of road surface is raised up to 60° C. in the Indian climate.)

### Experiment 4A: Preparation of Sulphur Extended Asphalt Using Sulphur Additive (Containing Aluminosilicate with Caustic/Ultrasonic Treatment)

Experimental procedure was followed as given in Experiment 2A. The results are shown in Table 4A.

TABLE 4A
H₂S emission with increasing mixing temperature

| sulphur | | | | |
|---|---|---|---|---|
| additive | Bitumen | Stirring rate | Temperature | H₂S emission on |
| (wt %) | (wt %) | (rpm) | (° C.) | detector (ppm) |
| 30 | 70 | 70 | 120 | 0 (undetectable) |
| 30 | 70 | 70 | 140 | 0 (undetectable) |
| 30 | 70 | 70 | 160 | 0 (undetectable) |
| 30 | 70 | 70 | 170 | 0 (undetectable) |
| 30 | 70 | 70 | 180 | 4 |

No emission of hydrogen sulphide (H₂S) and sulphur dioxide (SO₂) was observed till 170° C. 4 ppm H₂S was observed at 180° C.

### Experiment 4B: H₂S Emission from Sulphur Extended Asphalt with Increasing Temperature

The experimental procedure was followed as given in Experiment 2B using sulphur extended asphalt of Experiment 4A.

TABLE 4B
H₂S emission with increasing temperature

| SEA (wt %) | Temperature (° C.) | H₂S emission on detector (ppm) |
|---|---|---|
| 100 | 40 | 0 (non-detectable) |
| 100 | 60 | 0 (non-detectable) |
| 100 | 80 | 0 (non-detectable) |

(The H₂S detection experiments are conducted up to 80° C. on the basis of the fact that the maximum temperature of road surface raised up to 60° C. in the Indian climate.)
No emission of hydrogen sulphide (H₂S) and Sulphur dioxide (SO₂) was observed throughout the experiment indicating efficacy assurance during field application.

### Experiment 5: Compaction Test

A flask was charged with 14 g of bitumen and heated at 165° C. to obtain a heated bitumen. 380 g of gravel (aggregates as per mix design, preheated at 170° C.) was added to the heated bitumen to obtain a slurry. The slurry was continuously stirred to get a homogeneous mixture. 6 g of sulphur additive was added to the homogeneous mixture and stirred to a speed of 100 rpm. The homogeneous mixture was aged at 135° C. for 4 hours followed by aging at 150° C. for 30 minutes. Further, the homogeneous mixture was pressed at 150° C. and 600 kPa. No emission of hydrogen sulphide (H₂S) and sulphur dioxide (SO₂) was observed throughout the experiment.

### TECHNICAL ADVANCEMENTS

The present disclosure described herein above has several technical advantages including, but not limited to, the realization of:
a sulphur additive that reduces/suppresses H₂S emission during the preparation of SEA at a temperature greater than 80° C.;
a sulphur additive that comprises re-used/spent aluminosilicate; and
a process for the preparation of the sulphur additive that is economically viable.
   Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results. While certain embodiments of the inventions have been described, these embodiments have been presented by way of example only, and are not intended to limit the scope of the inventions. Variations or modifications to the formulation of this invention, within the scope of the invention, may occur to those skilled in the art upon reviewing the disclosure herein. Such variations or modifications are well within the spirit of this invention.

The numerical values given for various physical parameters, dimensions and quantities are only approximate values and it is envisaged that the values higher than the numerical value assigned to the physical parameters, dimensions and quantities fall within the scope of the invention unless there is a statement in the specification to the contrary.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

1. A sulphur additive for preparing sulphur extended asphalt, said sulphur additive comprising:
a) sulphur in an amount ranging from 80 to 98 wt % of the sulphur additive; and
b) at least one aluminosilicate in an amount ranging from 2 to 20 wt % of the sulphur additive.

2. The sulphur additive as claimed in claim 1, wherein said at least one aluminosilicate has an ordered porous structure with pore size ranging from 4 to 8 Å.

3. The sulphur additive as claimed in claim 1, wherein said at least one aluminosilicate includes at least one metal ion in its framework, said at least one metal ion is selected from the group consisting of alkali metals, alkaline earth metals, rare earth metals and transition metals.

4. The sulphur additive as claimed in claim 3, wherein said metal ion is inherently present or introduced in the framework of said at least one aluminosilicate.

5. The sulphur additive as claimed in claim 1, wherein said additive is molded into at least one solid shaped article selected from the group consisting of pastilles, flakes, extrudates and granules.

6. The sulphur additive as claimed in claim 1, wherein said at least one aluminosilicate is at least one selected from the group consisting of virgin aluminosilicate and a spent aluminosilicate catalyst.

7. The sulphur additive as claimed in claim 1, wherein said at least one aluminosilicate is modified aluminosilicate, said modified aluminosilicate is prepared by one of the following processes:
a) treating said aluminosilicate with at least one metal salt solution containing at least one adsorbent at ambient temperature for a time period in the range of 1 to 8 hours to obtain a mixture; filtering said mixture to obtain a residue; washing and drying said residue to obtain said modified aluminosilicate; and
b) treating said aluminosilicate contained in a spent catalyst with a caustic aqueous solution to a temperature in the range of 30 to 60° C. for a time period in the range of 10 to 40 hours or sonicating for a time period in the range of 10 to 120 minutes or heating with a caustic powder to a temperature in the range of 400 to 800° C. for a time period in the range of 1 to 4 hours to obtain a mixture; hydrothermally heating said mixture at temperature in the range of 70 to 100° C. under autogenic pressure for a time period in the range of 15 to 40 hours to obtain said modified aluminosilicate.

8. The sulphur additive as claimed in claim 7, wherein said adsorbent is zeolite or mixture of zeolites with at least one zeolite having pore size ranging from 4 to 8 Å.

9. A process for the preparation of a sulphur additive as claimed in claim 1, said process comprising the following steps:
a) introducing sulphur in the reactor and heating said sulphur to obtain a molten sulphur;
b) adding at least one aluminosilicate to said molten sulphur to obtain a mixture;
c) heating and stirring said mixture at temperature up to 170° C. to obtain a slurry; and
d) cooling said slurry to obtain the sulphur additive.

10. The process as claimed in claim 9, wherein the ratio of the amount of said aluminosilicate and the amount of said sulphur is in the range of 1:4 to 1:15.

11. The process as claimed in claim 9, wherein said sulphur and said aluminosilicate are mixed together before introducing in the reactor.

12. A process for the preparation of sulphur extended asphalt using the sulphur additive of claim 1, said process comprising the following steps:
a. introducing bitumen in a reactor;
b. heating said bitumen to obtain a heated bitumen; and
c. mixing said heated bitumen and said sulphur additive to obtain sulphur extended asphalt.

13. The process as claimed in claim 12, wherein the step of mixing said heated bitumen and said sulphur additive to obtain sulphur extended asphalt is carried out at a temperature in the range of 110 to 190° C., under stirring with a speed of less than 100 rpm.
